(19) United States
(12) Patent Application Publication
(10) Pub. No.: US 2020/0160386 A1
(43) Pub. Date: May 21, 2020

(54) CONTROL OF ADVERTISEMENT DELIVERY BASED ON USER SENTIMENT

(71) Applicant: International Business Machines Corporation, Armonk, NY (US)

(72) Inventors: Yuk L. Chan, Rochester, NY (US); Heidi LAGARES-Greenblatt, Jefferson Hills, PA (US); Jenny S. Li, Cary, NC (US); Deepti M. Naphade, Cupertino, CA (US); Xinlin Wang, Irvine, CA (US)

(21) Appl. No.: 16/193,217

(22) Filed: Nov. 16, 2018

(51) Int. Cl. G06Q 30/02

(52) U.S. Cl. CPC G06Q 30/0255; G06Q 30/0269

(57) ABSTRACT

Provided are embodiments for a method, system, and computer program product for controlling delivery of advertisements based on user sentiment. The embodiments provide for receiving user information for a user, receiving an advertisement based at least in part on the user information, and detecting a sentiment of the user, wherein detecting the sentiment utilizes one or more sensors to determine a sentiment of the user. The embodiments also provide for inhibiting transmission of the advertisement based at least in part on the detected sentiment, and providing a recommendation of a time to deliver the advertisement to the user based at least in part on the detected sentiment.

### BACKGROUND

The present invention generally relates to computing networks, and more specifically to controlling delivery of advertisements based on user sentiment.

Advertisements are used to attract new customers and provide existing customers information related to the offered goods and services. Advertisements can be provided to a user in a variety of ways including audio message, video clips, and the like. In addition, the advertisement can be presented on a user device display in a banner provided at the top of a webpage, a video clip before streaming another video, as a link leading to another page, etc. However, if users are not in a particular mood to view an advertisement, they may not pay attention to the advertisement which can result in an advertisement service's wasted efforts. There may be a need to consider a user's emotional state when delivering an advertisement or a particular type of advertisement to the user.

### SUMMARY

Embodiments of the present invention are directed to a computer-implemented method for controlling delivery of advertisements based on user sentiment. A non-limiting example of the computer-implemented method includes receiving, by a processor, user information for a user; receiving an advertisement based at least in part on the user information; sensing an emotion of the user, wherein sensing the emotion utilizes one or more sensors to determine an emotional state of the user; inhibiting transmission of the advertisement based at least in part on the sensed emotion; and providing a recommendation of a time to deliver the advertisement to the user based at least in part on the sensed emotion.

Embodiments of the present invention are directed to a system for controlling delivery of advertisements based on user sentiment. A non-limiting example of the system includes a storage medium, the storage medium being coupled to a processor, where the processor is configured to receive user information for a user; receive an advertisement based at least in part on the user information; sense an emotion of the user; inhibit transmission of the advertisement based at least in part on the sensed emotion; and provide a recommendation of a time to deliver the advertisement to the user based at least in part on the sensed emotion.

Embodiments of the invention are directed to a computer program product for controlling delivery of advertisements based on user sentiment, the computer program product comprising a computer-readable storage medium having program instructions embodied therewith. The program instructions are executable by a processor to cause the processor to perform a method. A non-limiting example of the method includes receiving user information for a user; receiving an advertisement based at least in part on the user information; sensing an emotion of the user, wherein sensing the emotion utilizes one or more sensors to determine an emotional state of the user; inhibiting transmission of the advertisement based at least in part on the sensed emotion; providing a recommendation of a time to deliver the advertisement to the user based at least in part on the sensed emotion; and transmitting the advertisement at the recommended time to a user device.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in practicing the teachings herein;

FIG. 4 depicts a system for controlling delivery of advertisements based on user sentiment in accordance with one or more embodiments of the invention;

FIG. 5 depicts a flowchart for controlling delivery of advertisements based on user sentiment in accordance with one or more embodiments of the invention;

FIG. 6 depicts another flowchart for controlling delivery of advertisements based on user sentiment in accordance with one or more embodiments of the invention; and

FIG. 7 depicts a computer program product in accordance with one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

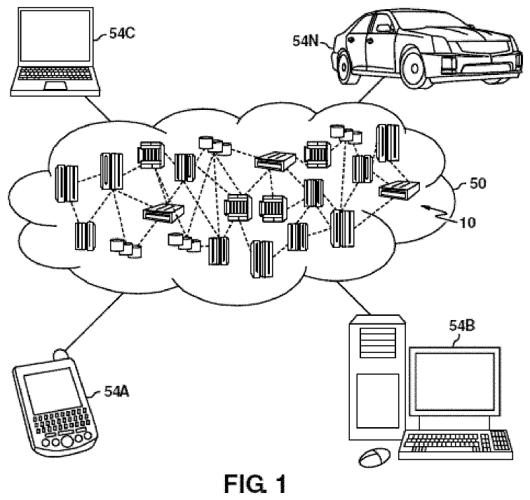

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

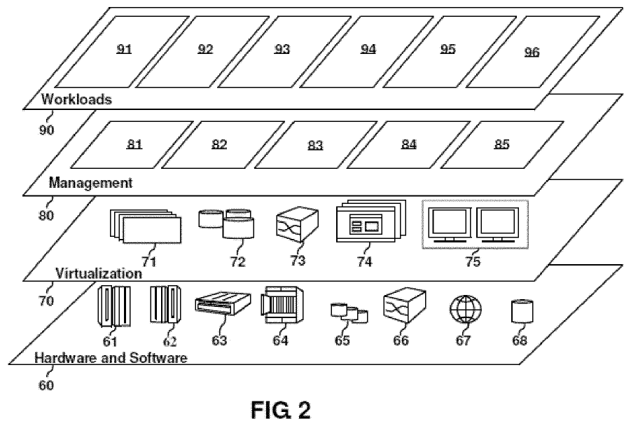

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and action analytics and notifications 96.

Turning now to an overview of technologies that are more specifically relevant to aspects of the invention, advertisements can be directed towards users and user devices based on several factors. For example, advertisements can be selected for a user based on the input from the user's search engine query. Keywords can be extracted from the search query and used to target advertisements to the users. The timing of the delivery of advertisements is critical for the success rate and effectiveness of the advertisement where current system do not consider a user's current emotional state. The success rate and effectiveness can be measured based on a user buying a product or service based on receiving the targeted advertisement.

By simply processing a user's search engine query, the targeting of advertisements may not be effectively provided to the user. In an example, although a user searches for a particular item, the user may not be in the mood to make a particular purchase at that moment. If a user is in a bad mood or ill, they may not feel like online shopping. However, other users may prefer to online shop when they are in a sad mood. If the user, a potential consumer, is not in the appropriate emotional state, an advertiser's efforts can become useless to try to entice them to purchase a good or a service. Scenarios may occur where people are experiencing a particular emotion where they may not care about certain advertisements for specific services or products over a period of time-based on the current mood.

For example, a user that is a sports enthusiast may not want to purchase merchandise related to a particular his team after his team loses. Therefore, advertisements that are sports related may not have a high success rate. In another example, a user that has lost his pet may not want to search for pet accessories or receive online advertisements related to pets in the near future.

The current techniques fail to factor the human emotional aspect when delivering an advertisement to users. The techniques are directed towards delaying the timing of the delivery of advertisements based on the detected user's mood to increase the likelihood that the user will make a purchase or follow the link provided by the advertisement. The techniques described herein can provide recommendations to hold/delay/accelerate advertisement appropriately based on the emotional state of an individual or a group. In addition, the techniques described herein can provide for prioritized timing based on the extracted emotional state of not only the individual user but a group of users. The techniques described herein can provide recommendations based on a group threshold. The techniques described herein determine how a user emotion is correlated to a conversion rate of an application to make targeted advertisements more effective. If the timing of the delivery of the advertisement is not optimized, the effectiveness and conversion rate of a targeted advertisement services may have missed an opportunity for completing a sale or having a user following a link related to the advertisement.

Turning now to an overview of the aspects of the invention, one or more embodiments of the invention address the above-described shortcomings of the prior art by providing a technique to defer or target advertisement delivery to a user based on a user's current emotion. The above-described aspects of the invention address the shortcomings of the prior art by optimizing advertisement timing delivery to users by detecting a user's mood.

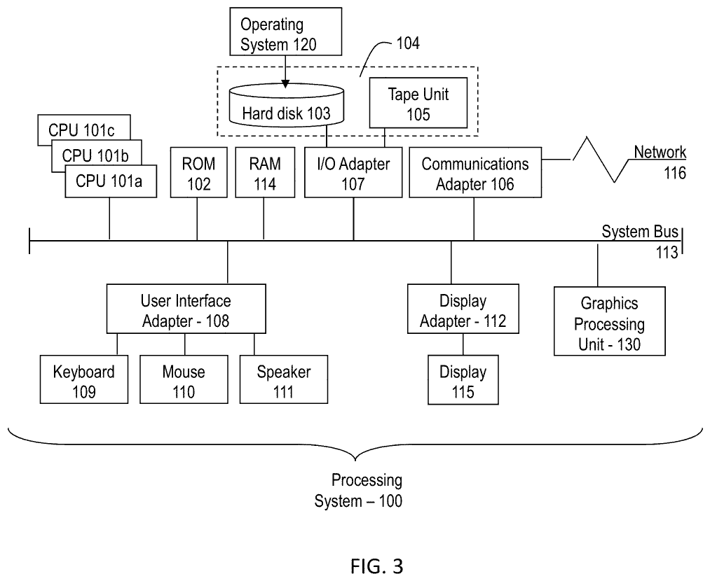

Turning now to a more detailed description of aspects of the present invention, FIG. 3 an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

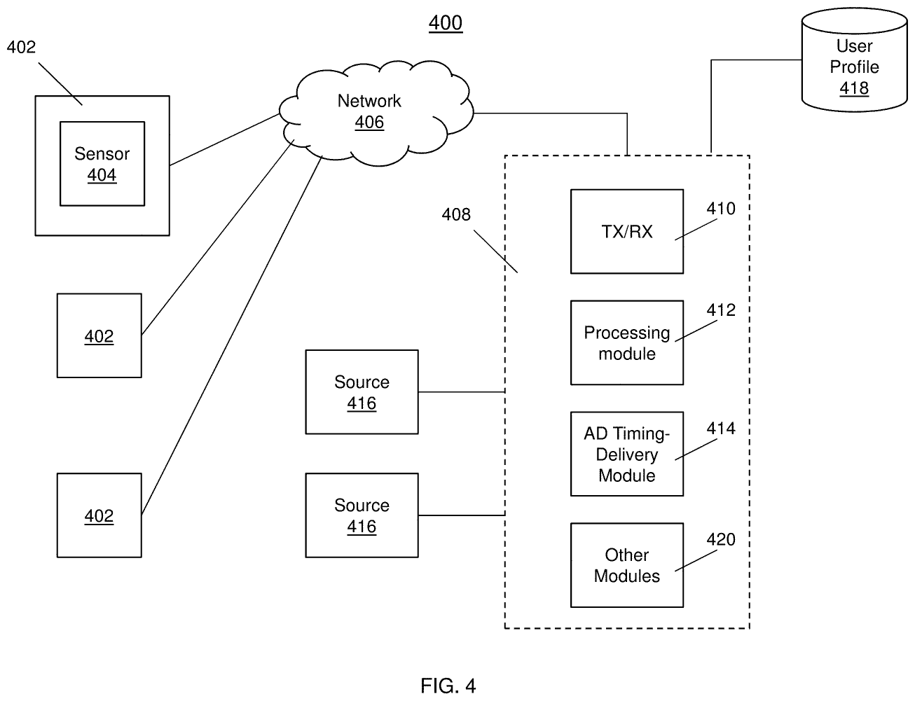

Now referring to FIG. 4 a system 400 for controlling delivery of advertisements based on user sentiment in accordance with one or more embodiments is shown. The system 400 includes a one or more user devices 402 that can be used to receive advertisements from a plurality of sources through a network 406. The user devices 402 can include mobile devices, laptops, tablets, etc. Advertisements can include audio and/or video presentations. The advertisements can provide links for the user to follow. The user devices 402 can present the advertisements on the user devices 402.

User devices 402 can also include one or more sensors 404 to detect a mood or emotional state. The sensors 404 can include biometric sensors, video cameras, image detection devices, audio devices, etc. It should be understood that other types of sensors can be used to detect the mood of the user. In one or more embodiments of the invention, the sensors can be used to detect a mood based on detecting a person's speech, facial expressions, physiological signals, etc.

In one or more embodiments of the invention, the system 400 can perform a sentimental analysis on text or audio and can be performed by the user device 402, server 408, or other device/system. The sentiment analysis module may be provided by an application program interface (API) or a natural language understanding API. The above mentioned APIs are mentioned for exemplary purposes. Any cognitive AI can be utilized within the sentiment analysis module. The sentiment analysis module can process natural language to incorporate both a linguistic and statistical analysis in evaluating the context of a communication. In text analysis, the sentiment is the attitude or opinion expressed toward something. Sentiment can be positive, “sounds good”, negative, “this is bad”, or neutral. Sentiment can be calculated based on keywords extracted and evaluated at a keyword level. Additionally, the sentiment analysis may be capable of identifying negations, such as the term “not” and the change in sentiment from the keyword “good” when the phrase is “not” “good”. The sentiment analysis may consider intensity when the terms “very” or other adjectives are utilized in combination with a keyword. Additionally, the keywords may be weighted. For instance, a positive phrase such as “like” will have a predefined positive weight, whereas the phrase “love” might have a higher predefined positive weight. Additionally, negative weights may be afforded negative phrases such as “dislike” would have a predefined negative weight and the phrase “hate” might have a higher negative weight. The sentiment analysis module can evaluate the content to provide a sentiment level. This sentiment level may also include an intensity value.

The tonal analysis module may be tone analyzer service, for example. The tonal analysis module can use linguistic analysis to detect three types of tones from the text. The natural language content is analyzed by the tonal analysis module for determining the emotional impact, social tone, and writing style that the content projects. The tonal analysis module may provide tonal scores for emotional tone, social tone, and language tone. For emotional tone, the tonal analysis module may utilize the emotions for “joy”, “fear”, “sadness”, “disgust” and “anger”. Each natural language element is evaluated with respect to each emotion. Each emotion may be evaluated from lower values having a value range that indicates if that emotion is less likely to appear as perceived or alternatively to a higher value range if the emotion is more likely to be perceived with respect to each natural language content. Other emotions may be utilized as well as a different value score.

For social tone, the five elements of openness, conscientiousness, extraversion, agreeableness, and emotional range are utilized. Openness is evaluated as the extent a person is open to experience a variety of activities. This trait may be provided a value range indicating that it is more likely to be perceived as no-nonsense, straightforward, blunt and obvious, alternatively, a higher value range may be provided if the content indicates that it will be perceived as intellectual, curious, emotionally-aware, or imaginative. Conscientiousness is evaluated as the tendency to act in an organized or thoughtful way. This trait may be provided a value range if the presentation is perceived as spontaneous, laid-back, reckless, unmethodical or disorganized, or alternatively, a higher value range may be provided if the content is perceived as disciplined, dutiful, or confident. Extraversion is evaluated as the tendency to seek stimulation in the company of others. This trait may be provided a value range if perceived as independent, timid, introverted, restrained, boring, or alternatively, a higher value range may be provided if the content is perceived as engaging, seeking attention, assertive, sociable. Agreeableness is evaluated as the tendency to be compassionate and cooperative towards others. This trait may be provided a value range if the presentation is perceived as selfish, uncaring, uncooperative, confrontational or arrogant, or alternatively, a higher value range may be provided if the content is perceived as caring, sympathetic, cooperative, or trustworthy. The emotional range is evaluated as the tendency to be sensitive to the environment. This trait may be provided a value range if the presentation is perceived as calm, bland, content, relaxed or alternatively a higher value range may be provided if the content is perceived as concerned, frustrated angry, passionate, upset, stressed or impulsive. These tones, descriptions, and weights are merely illustrative and additional tones, descriptions or weights may be utilized.

Language tones may be analyzed to measure the user's writing style. The various styles may include analytic, confidence and tentative. The analytic style may focus on the individual's reasoning and analytical attitude about things. The analytic style may be provided a value range if the text contains little or no evidence of analytical tone or alternatively a higher value range if the presentation is more likely to be perceived as intellectual, rational, systematic, emotionless, or impersonal. The confidence style may focus on the presenter's degree of certainty. The confidence style may be provided a value range if the text contains little or no evidence of confidence in tone or alternatively a higher value range if the style is more likely to be perceived as assured, collected, hopeful or egotistical. The tentative style may focus on the presenter's degree of inhibition. The tentative style may be provided a lower value range if the text contains little or no evidence of tentativeness in tone or a higher value range if the style is more likely to be perceived as questionable, doubtful limited, or debatable. The word stemming and summation module.

The server 408 includes a TX/RX module 410 to communicate with other devices either directly or indirectly over network 406. The server 408 also includes a processing module 412 that is configured to perform one or more operations of the invention. Ad timing and delivery module 414 is configured to receive the data from the processing module 412 to delay an advertisement or match the advertisement with an optimal time period for delivery to the user. The server 408 includes other modules 420. The system 400 also includes a server 408 that communicates with user devices 402 and other internal/external devices and systems.

The server 408 is coupled to one or more sources 416. The sources 416 can include advertisement services that are configured to transmit advertisements and content to users directly to user devices 402 or indirectly through the server 408 to the user devices 402. In addition, the sources 416 can provide information provided by social media platforms, news outlets, etc. For example, the server 408 can obtain information from a user's posts in a social media platform to determine a user mood using the sentiment analysis described above. In another example, trending news can be used to determine a user's mood. In addition, a community or group the user is associated with can be used to determine a user's mood or a group mood. For example, local news and national news can have varying impact on a user. In addition, the server 408 can have access to a user's calendar to determine a particular event that may impact a user's mood. The server 408 can obtain news regarding a news event from a source 416 and can be correlated to the user's location where the proximity of the news event can impact the user's mood. The location can be determined using known techniques including GPS location data, location information, network address information, etc.

Responsive to determining a user's mood, the correlation to a particular advertisement can be determined. For example, various advertisements can include data such as tag information or attribute information indicating a type of product or service that can be compared/correlated to the user's mood. For example, a product for wedding, birthday, etc. can be determined to be searched for or purchased when a user is in a happy mood. In addition to tag and attribute information that can be provided by an advertisement service, the tag and attribute information can be based on user reviews of the product or service, crowd-sourced information, etc.

In one or more embodiments of the invention, the attribute information of an advertisement for a product or service can be obtained by the server 408 from a source 416 such as an advertisements service. In addition, crowd-sourced information can be obtained by the server 408 from social media platform comments, reviews, posts, etc. regarding the advertisement. By associating the user's current mood to the delivery of an advertisement the conversion rate by the advertisement's targeted users can be increased. For example, if the user is in a happy mood, advertisements related to weddings, birthdays, etc. can be provided to the user. If the user is in a bad mood, these types of advertisements will be delayed and a future recommendation of a time to deliver the advertisement to the user will be provided. For example, if it is determined that a user is in a bad mood, advertisements that are associated with happy moods can be delayed for a period of hours, days, weeks, months, etc. In addition, the delay can be based on the intensity of the user's mood. For example, if a news outlet indicates a national tragedy that occurred in close proximity to the user's location, happy advertisements can be delayed for a longer period of time when compared to a user that posted information indicating a bad mood in a social media platform due to morning rush hour traffic the user experienced.

In one or more embodiments of the invention, a group threshold can be used to determine whether to delay a particular advertisement based on the mood and advertisements affecting a group. For example, national news indicating an earthquake, storm, or other weather event may not put users in the mood to book vacations to the impacted area. As a result, those advertisements can be delayed for a period of time. It should be understood the group threshold can be configured according to the size of the group, whether the group is a school, a city, an interest group, or other type of group. The information impacting the groups can be obtained from news sources or social media sources.

User profile database 418 can be coupled to the server 408 and can be configured to store a mapping between a user mood and advertisements to avoid inappropriate timing. The history of the user is tracked over a period of time where the history can identify trends in the user behavior indicating that a user likes particular advertisements when experiencing certain moods and does not like certain advertisements during other moods. For example, the user that is in a bad mood may prefer to shop for ice cream where another user prefers to stream movies. This type of information can be stored in the user profile database 418 and leveraged to target the appropriate advertisements at optimal times. Conversion rate and efficacy rates can also be stored and used to provide the advertisements. The conversation rate information can include information indicating a click-rate and/or completing a purchase for particular advertisements. A conversion rate threshold can be used to determine when to defer the advertisement. The techniques described herein provide for deferring advertisement to a later time and matching certain advertisements based on the user mood.

In one or more embodiments of the invention, advertisement systems can implement a charging system that factors the prioritization or conversion rate for recommending and targeting advertisements.

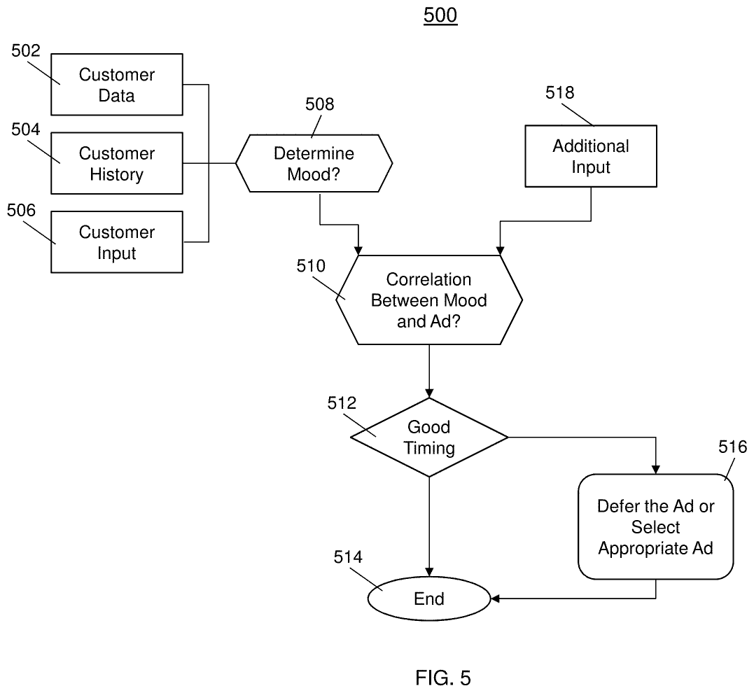

Now referring to FIG. 5, a flowchart for a method 500 for controlling delivery of advertisements based on user sentiment is shown. The method 500 can be implemented by any of the systems shown in FIGS. 1-4. For example, a server 408 obtains the customer data 502, customer history information 504, and customer input 506 (text/visual/voice/event data). The customer data 502 includes information related to a user's preferences such as a brand of products, type of item, colors (user preference data) behavior, etc. The customer history information 504 includes purchase history, browsing history, etc. The customer input 506 includes can be used to determine a user is in a bad mood. For example, a user voice can be analyzed; an activity level on social media can be determined; content of the user text or message can be analyzed; etc. and can be compared to the user's average or normal mood or behavior that has been monitored and tracked over a period of time. In addition, the biometric data can detect a high blood pressure, heart rate, etc. At block 508, the method 500 can be executed in a server 408 to determine the current mood or emotional state of the user by receiving sensor data from a user device 402 or another source.

Next, the method 500 continues to block 510 to determine whether there is a correlation between the advertisement and the user's mood. If at block 510 a correlation is determined between the advertisement and the mood, then the method 500 continues to block 512 to determine whether it is a good time to transmit the advertisement to a user. The advertisements can include attribute information that is processed by the processing module to determine a type of advertisements and compared to the user mood to decide whether the correlation exists between the user's mood and the attribute information of the advertisement. The attribute information can be mapped to a user's mood in storage or database such as the user profile database 418. It should be understood that other inputs 518 can be received to determine the correlation between the user's mood and the advertisement. The correlation can be based on a stored mapping in a history database, user profile, group profile, etc. between a given mood and a type of advertisements.

If at block 512 it is determined that it is not a good time to send the advertisement, a more appropriate advertisement can be sent to the user if a particular advertisement is deemed inappropriate. In one or more embodiments of the invention, the server 408 can recommend or suggest a future time to send the advertisement as shown at block 516. In another embodiment of the invention, the particular advertisement can be delayed or placed on hold for a configurable/default period of time as shown at block 514. In one or more embodiments of the invention, items that are less targeted to the user can be provided or an advertisement that a user had not seen before if the timing is inappropriate. In another embodiment, an advertisement can be selected based on filling a time slot. At block 512, it is determined that the timing is appropriate, (i.e., if the user's detected mood matches the attribute information of an advertisement) the advertisement is pushed to the user device 402. The method 500 ends at block 514.

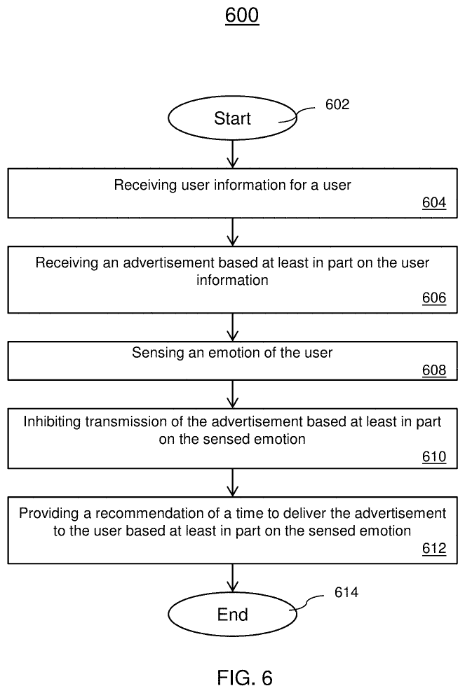

FIG. 6 also depicts another flowchart of a method 600 for controlling delivery of advertisements based on user sentiment. The method 600 begins at block 602 and continues to block 604 that provides for receiving user information for a user. The flowchart includes obtains the customer data, customer history information, and customer input (text/visual/voice/event data). At block 606 the method 600 provides for receiving an advertisement based at least in part on the user information. The method 600 at block 608 provides for sensing an emotion of the user. Block 610 provides for inhibiting transmission of the advertisement based at least in part on the sensed emotion. Block 612 includes providing a recommendation of a time to deliver the advertisement to the user based at least in part on the sensed emotion. The method 600 ends at block 614.

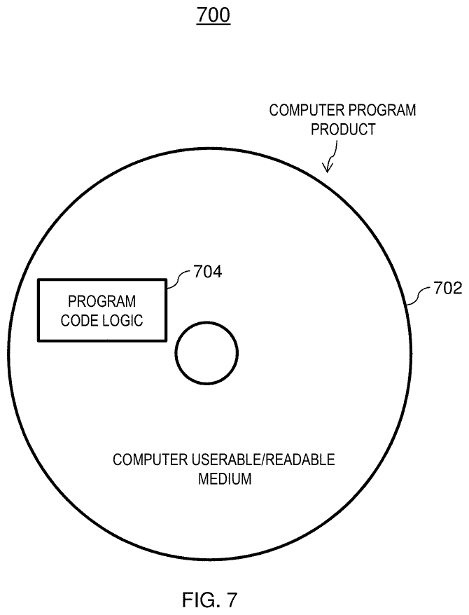

Referring now to FIG. 7, a computer program product 700 in accordance with an embodiment that includes a computer-readable storage medium 702 and program instructions 704 is generally shown.

The techniques described herein improve over the prior art by recommending the timing for delivering an advertisement to a user based on the user's emotion. The techniques described herein also factors a plurality of user inputs to increase the probability that the emotional state of the user is properly detected. The techniques can either defer a particular advertisement and/or match an advertisement based on a user's particular mood.

In a non-limiting example, it can be determined that a user is looking at a kitchen appliance based on a search that is performed in the morning. Using the techniques described herein, the user's mood will be used to determine if there is a better time to present the advertisement to the user. If a better time is not determined, the advertisement will be presented to the user. However, if there is a better time, advertisements in the appliance category will be specially tagged to be considered at a later time. Continuing with the example, the user begins performing a search related to a sport in the evening. Without this invention, the appliance related advertisements will have a higher priority to be presented to the user in the morning, while the sports related advertisements will have a higher priority to be presented in the evening. With this invention, the kitchen appliance related advertisements will be considered together with the sports related advertisements in combination with a timestamp that user has shown interest in the product category. Based on the user's emotional state and behavior, if the advertisement system determines that appliance advertisements will be more effective than the sports advertisements, then the user will be presented with a higher number of appliance advertisements and less sports advertisements. If the advertisement system determines that sports advertisements are not effective at this time, the sports advertisements can be tagged to be considered at a later time. On the other hand, if the advertisement system determines that sports advertisements and appliance advertisements are equally effective, the elapsed time from the “show of interest” will be considered. For some advertisement categories or emotional states, the longer elapsed time might increase the conversion rate, while for other advertisement categories or emotional states, the longer elapsed time might decrease the conversion rate.

In another non-limiting example, the advertising system can provide multiple levels of services to an advertiser based on the likelihood of a user making a purchase. The different level of services can be identified using the emotional state and user behavior. The level of services can include a “high level” which indicates high confidence that a user will make a purchase for the specific product; a “medium level” which indicates a medium confidence that a user will make a purchase for the specific product; or a “low level” which indicates a low confidence that a user will make a purchase for the specific product. In a different non-limiting example, a specific advertisement can be provided when a particular program is provided and a particular mood is detected such as presenting the advertisement when the user is in happy mood after a sports game”. It should be understood that any number of service levels can be used to provide different levels of granularity to the advertisement system.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for performing emotion-awareness timing delivery of advertisements, the computer-implemented method comprising:
receiving, by a processor, user information for a user;
receiving an advertisement based at least in part on the user information;
sensing an emotion of the user, wherein sensing the emotion utilizes one or more sensors to determine an emotional state of the user;
inhibiting transmission of the advertisement based at least in part on the sensed emotion; and
providing a recommendation of a time to deliver the advertisement to the user based at least in part on the sensed emotion.

2. The computer-implemented method of claim 1, wherein inhibiting the transmission of the advertisement is based at least in part on a group threshold.

3. The computer-implemented method of claim 1, wherein inhibiting the advertisement for a period of time is based at least in part on one of the sensed emotion or a detected event.

4. The computer-implemented method of claim 1, further comprising matching the advertisement with a period of time based at least in part on one of the sensed emotion or a detected event.

5. The computer-implemented method of claim 1, further comprising transmitting the advertisement at the recommended time to a user device.

6. The computer-implemented method of claim 1, further comprising selecting the advertisement based on one or more advertisement service levels, where each of the one or more advertisement service levels indicate a probability the selected advertisement results in a purchase.

7. The computer-implemented method of claim 1, further comprising:
determining a conversion rate of an advertisement based at least in part on the sensed emotion; and
updating the recommended time to deliver the advertisement based on the conversion rate.

8. A system for performing emotion-awareness timing delivery of advertisements, the system comprising:
a storage medium, the storage medium being coupled to a processor;
the processor configured to:
receive user information for a user;
receive an advertisement based at least in part on the user information;
sense an emotion of the user;
inhibit transmission of the advertisement based at least in part on the sensed emotion; and
provide a recommendation of a time to deliver the advertisement to the user based at least in part on the sensed emotion.

9. The system of claim 8, wherein inhibiting the transmission of the advertisement is based at least in part on a group threshold.

10. The system of claim 8, wherein sensing the emotion comprises utilizing a plurality of sensors to determine an emotional state of the user.

11. The system of claim 8, wherein inhibiting the advertisement for a period of time is based at least in part on one of the sensed emotion or a detected event.

12. The system of claim 8, wherein the processor is further configured to match the advertisement with a period of time based at least in part on one of the sensed emotion or a detected event.

13. The system of claim 8, wherein the processor is further configured to transmit the advertisement at the recommended time to a user device.

14. The system of claim 8, wherein the processor is further configured to:
determine a conversion rate of an advertisement based at least in part on the sensed emotion; and
update the recommended time to deliver the advertisement based on the conversion rate.

15. A computer program product for performing emotion-awareness timing delivery of advertisements, the computer program product comprising a computer-readable storage medium having program instructions embodied therewith, the program instructions executable by a processor to cause the processor to:
receive, by a processor, user information for a user;
receive an advertisement based at least in part on the user information;
sense an emotion of the user;
inhibit transmission of the advertisement based at least in part on the sensed emotion;
provide a recommendation of a time to deliver the advertisement to the user based at least in part on the sensed emotion; and
transmit the advertisement at the recommended time to a user device.

16. The computer program product of claim 15, wherein inhibiting the transmission of the advertisement is based at least in part on a group threshold.

17. The computer program product of claim 15, wherein sensing the emotion comprises utilizing a plurality of sensors to determine an emotional state of the user.

18. The computer program product of claim 15, wherein inhibiting the advertisement for a period of time is based at least in part on one of the sensed emotion or a detected event.

19. The computer program product of claim 15, wherein the program instructions are further executable by the processor to cause the processor to match the advertisement with a period of time based at least in part on one of the sensed emotion or a detected event.

20. The computer program product of claim 15, wherein the program instructions are further executable by the processor to cause the processor to:
determine a conversion rate of an advertisement based at least in part on the sensed emotion; and
update the recommended time to deliver the advertisement based on the conversion rate.
